(19) United States
(12) Patent Application Publication
(10) Pub. No.: US 2002/0054576 A1
(43) Pub. Date: May 9, 2002

(54) Distributed asynchronous transfer mode (ATM) switch architecture for satellites

(75) Inventor: Richard L. Gobbi, Potomac, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Astrolink International, LLC

(21) Appl. No.: 09/975,936

(22) Filed: Oct. 15, 2001

Related U.S. Application Data
(60) Provisional application No. 60/239,884, filed on Oct. 13, 2000.

(51) Int. Cl. H04B 7/185

(52) U.S. Cl. 370/316; 370/310.1; 455/12.1

(57) ABSTRACT

The invention provides a communications network utilizing a multi-beam input/multi-beam output fixed-sized data packet switch with configurable output packet buffering located in a satellite. The satellite communications network system according to the invention handles fixed size data packets and includes ground based stations (terminals) for transmitting an up-link communication signal representing the fixed sized data packets and for receiving a control signal, a satellite for receiving the up link communication signals from the ground based stations and for transmitting down-link communication signals, and a ground control station for transmitting and receiving control signals to the satellite, whereby the satellite receives and transmits the control signals to the ground based stations.

### CROSS REFERENCE TO RELATED APPLICATIONS

This application claims priority from U.S. Provisional Patent Application No. 60/239,884 entitled, A DISTRIBUTED ATM SWITCH ARCHITECTURE FOR SATELLITES, filed on Oct. 13, 2000, the entirety of which is herein incorporated by reference.

### BACKGROUND OF THE INVENTION

1. Field of the Invention

The invention relates generally to a communications network system, and more particularly, to a communication network system utilizing a satellite system for data transmission.

2. Description of Related Art

The evolution of communication system technology since the early 1960's, when packet-switching was invented for military applications, has involved the emergence of a wide variety of techniques and technologies not envisioned even by many of the pioneers. During the same period, communication satellite technology evolved very rapidly. Both of these technologies grew due to the needs of the military. They are now being combined to address an emerging need for quickly-installed, configurable, bandwidth-on-demand platforms and access devices to interconnect a geographically dispersed consumer and business enterprise market base.

ATM the transmission of voice, data, video over the same communication channel at varying speeds using 53-byte packets, called cells. The ATM Standard was developed in order to provide a connection-oriented service using cell switching and multiplexing to accommodate high bandwidth operation. It allows variable-bite rate and best-effort services to be transmitted over the same media, be it cable, fiber, or via wireless channels, as low-required-delay real-time services. It accomplishes this by enabling statistical multiplexing wherein multiple sources are allocated cell slots under control of a bandwidth management system which is not part of the standard.

Each ATM cell has a 5-byte header which includes a field called a VPI/VCI (virtual path indicator/virtual channel indicator). These are labels that have local significance. A switch maps an input virtual path/virtual circuit to an output virtual path/virtual circuit based on a VPI/IVCI connection map between switch input and output. In most switch implementations, internal routing information is added to the cells in order to carry out the mapping, but these are not covered by the standard. All endpoint address information, and the mapping of this information to VPI/VCI labels along paths between switches, is carried out by the ATM control layer.

ATM systems have generally been used in terrestrial systems for voice communications. In contrast, conventional satellite communication systems have been employed for communications where the satellites typically act as “repeaters” for transmitting a ground based signal from one base station to a second base station. These conventional satellite communication systems do not process the received signals, but instead take advantage of the capability of satellites to transmit signals across great distances.

### SUMMARY OF THE INVENTION

Accordingly, the invention provides a communications network utilizing a multi-beam input/multi-beam output, fixed-sized-packet switch with configurable output packet buffering located in a satellite. The switch switches inbound packets to outbound packets using address switching applied to fixed size address fields of the packets. The satellite switch enables a mesh topology between applications hooked to ground user terminals. The use of multiple logical (usually called virtual) circuits from user terminals, multiplexed into inbound beams, switched through the satellite switch, and then re-multiplexed into outbound beams and de-multiplexed by ground user terminals, enables a logical mesh topology between user applications wherein each user terminal serves as a platform for the exchange of data to and from the applications hooked to it. The network is connection-oriented in that all virtual circuits are established prior to user application data transfer.

The invention also provides for a central ground based station, or network control center (NCC), for control of the switch processing and associated inbound beam processing and outbound beam processing with distributed aid via protocols carried over virtual circuits from the user terminals in each inbound and outbound beam.

In accordance with these features, the invention provides a satellite communications network system for handling fixed size data packets that includes ground based stations (terminals) for transmitting an up-link communication signal representing the fixed sized data packets and for receiving a control signal, a satellite for receiving the up-link communication signals from the ground based stations and for transmitting down-link communication signals, and a ground control station for transmitting and receiving control signals to the satellite, wherein the satellite receives and transmits the control signals to the ground based stations.

### BRIEF DESCRIPTION OF THE DRAWINGS

The invention is described in relation to the following drawings, in which like reference symbols refer to like elements, and wherein:

FIG. 1 shows a satellite network communications system in accordance with an embodiment of the invention;

FIG. 2 shows a logic diagram of the network control center in accordance with an embodiment of the invention;

FIG. 3 shows a block diagram of a terminal for the satellite network communications system shown in FIG. 1; and

FIG. 4 shows an exemplary channelization diagram which can be controlled by the network control center of the invention.

### DETAILED DESCRIPTION OF PREFERRED EMBODIMENTS

Reference will now be made in detail to embodiments of the invention, examples of which are illustrated in the accompanying drawings.

As described above, the satellite network communications system in accordance with the invention deals with the communication of fixed size data packets and more particularly, ATM (Asynchronous Transfer Mode) packets, or cells. To illustrate the invention, the following embodiments describe the transmission of signals carrying ATM packets. The invention, however, can be also used to handle other fixed size data packets.

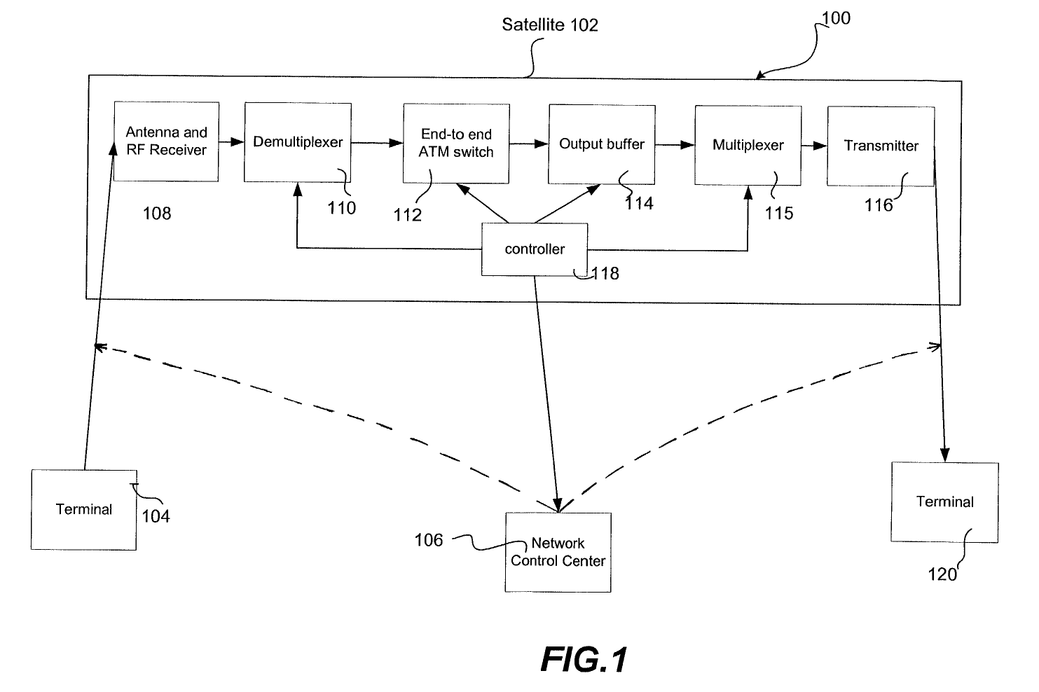

FIG. 1 shows the satellite network communication system 100 in accordance with one embodiment of the invention. The satellite network communication system 100 includes a satellite 102, a first ground based station, or terminal 104, a network control center 106 (NCC) and a second ground based station, or terminal 120. The first ground based station 104 communicates with the network control center 106 and/or the second ground based station 120 via the satellite 102. ATM packets have fixed lengths and have routing codes, which we also refer to as addresses even though they only have per-link significance, so that ATM packets having the same ultimate destination and routing codes are sent via a common virtual circuit. The end-to-end pairing of destinations is determined, in ATM, by control signaling to the NCC prior to transmitting packets on a virtual circuit. The routing codes allow processing and switching of the packets at the first ground based station 104, at the ATM switch 112 and at the second ground based station 120. The routing codes also indicate the priority levels of the ATM packets so that the packets having higher priority are transmitted earlier, but in such a manner that no one virtual circuit is starved for bandwidth.

As shown in FIG. 1, the satellite 102 of the satellite network communications system 100 includes an antenna and RF receiver 108, a first signal processing device 110, an ATM switch 112, an output buffer 114, a second signal processing device 115, a transmitter 116 and a controller 118. The antenna and RF receiver 108 receives an inbound signal carrying ATM packets from the first ground based station 104 and sends the signal to the first signal processing device 110 for processing and recovery of the ATM packets. The ATM packets from the first ground based station 104 are multiplexed with packets of many other like terminals in the same beam as first ground based station 104. The first signal processing device 110 operates as a demultiplexer. The ATM packets output from the first signal processing device 110 are then switched, based on the address in the packets, to the output buffer 114 containing packets of the virtual circuit to the second ground based station 120 by the ATM switch 112. The addresses, i.e., routing codes, of the input packets are replaced by addresses significant to the link between the switch 112 and the second ground based station 120 by the switch 112.

Before transmission to various destinations (e.g., the second ground based station 120 or the network control center 106) by the transmitter 116, the fixed size data packets are first stored in the on-board output buffer 114. The buffer 114 is designed to output the packets to the second signal processing device 115 in such a manner as to minimize delay for real-time traffic and to buffer and transmit, when possible, bursts of packets from non-real time sources. In accordance with one embodiment of the invention, the buffer may include a number of sub-buffers (not shown) to store the ATM packets with different priorities and/or different Quality of Service (QoS). The second signal processing device 115 operates as a multiplexer for modulating and coding signals to be transmitted. Prior to transmission, the ATM packets are multiplexed into a stream by the second signal processing device 115 which is modulated onto a carrier for transmission into the beam for the second ground based station 120.

The controller 118 receives control signals from the network control center 106 for controlling the scheduling of packet output from each of the configurable sub-buffers of the buffer 114. In accordance with one embodiment of the invention, these sub-buffers are priority buffers which distinguish various types of real time and non-real time packet traffic. The distribution of the packets and the rates at which the packets are put into the aforementioned stream is governed by the network control center 106. In accordance with this embodiment of the invention, certain ATM packets require real-time transmission, and thus those signals are designated as having a higher transmission priority. The NCC 106 controls the priority level for the real-time ATM signals as is described in greater detail below.

In operation, the first ground based station 104 communicates with the second ground based station 120 and/or the network control center 106 by sending ATM packets via the satellite 102. Generally, the signals transmitted by the ground based station 104 include packets which carry messages to other ground based stations besides ground based station 120, and also contain packets which carry signaling messages to the network control center 106. In either situation, the ATM packets containing routing and priority codes are first transmitted to the satellite 102 as shown by the solid arrow of FIG. 1. The signals are then processed by the first signal processing device 110. The first signal processor 110 is ultimately a demultiplexer and may, for example, include demodulating and decoding functionality. Thus, the combined signal of the beam, containing the signal from the first ground based station 104 along with signals from many other like ground based stations, is demultiplexed in the first signal processing device 110.

After processing, the packets are switched to the appropriate sub-buffers of the output buffer 114 by the switch 112 according to the routing codes of the ATM packets. The buffer may be configured to have a fixed amount of buffering capacity allocated to each downlink beam. The buffering capacity may be matched to standard ATM Quality of Service (QoS). The NCC 106 can change a given allocation of buffer space to the QoS priorities, in order to allow a variation in traffic as a function of time. In accordance with one embodiment of the invention, there may be multiple buffers. In this case, the buffering output can be drained from respective buffers in a round-robin fashion.

Following buffering, the ATM packets are multiplexed into a stream by the second signal processing device 115. Each stream of packets corresponding to the respective output beams, are input to the transmitter 116. The transmitter 116 transmits a combined signal, containing packets to many other like ground based stations, along with the packets destined for ground based station 120.

The network control center 106 controls the communication traffic, transmission bandwidths and the transmission channels used by the ground based station 104 and 120 according to the congestion of the buffer 114 of the satellite 102, the amount of bandwidth used between the ground based station 104 and other like ground stations, the requests from the ground based stations 104 and 120 and the weather situation, e.g., the rain attenuation.

In accordance with the invention, the NCC 106 logically sends control signals to the controller 118 as shown by the solid transmission line 130. After processing by the controller, the control signals are sent to the ground based stations 104 and 120 as shown by the dotted lines 135 and 140.

Therefore, the network control center 106 will transmit control signals to the satellite 102 according to control information received from the ground based station 104 and/or 120, and other like ground stations, the congestion of the buffer 114 and/or the weather situation, e.g., the rain attenuation factor. The control signals are processed by the controller 118 to control the transmission rates of ATM packets and/or to change the virtual circuit assignments to sub-buffers of the buffer 114.

In certain situations, for example, when the ground based stations 104 and 120 need to transmit priority messages or a larger number of packets than usual, the ground based stations 104 and 120 can also send request signals to the network control center 106. The network control center 106 then grants or denies the requests based on a fairness criterion involving the requirements of all ground based stations and the priority levels of the respective virtual circuits of the ground based stations, which will be described later.

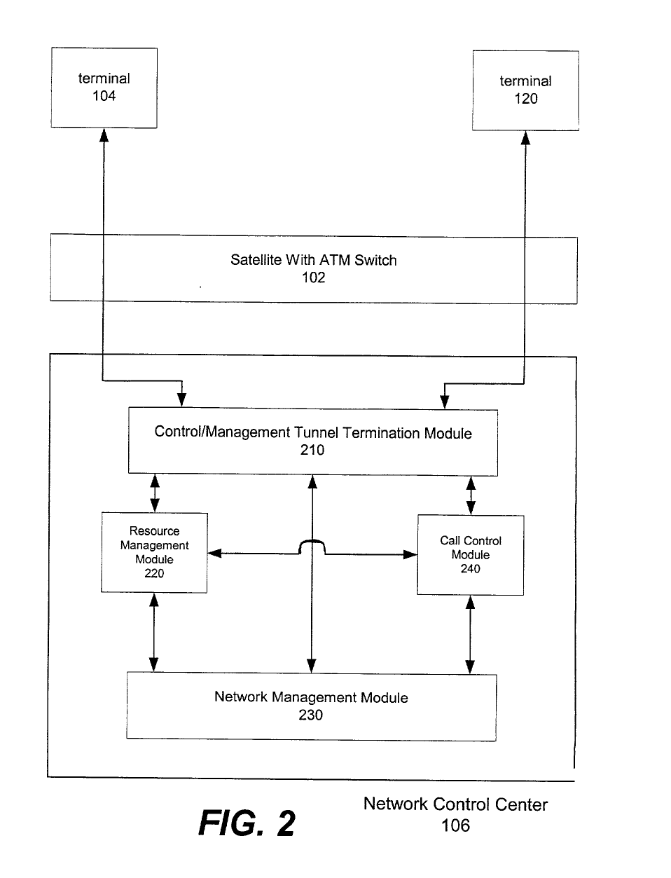

FIG. 2 is a logic diagram showing the operation of the NCC 106 in a great detail. In FIG. 2, the first ground base station 104 is communicatively coupled to the satellite 102 and the NCC 106. The second ground base station 120 is also communicatively coupled to the satellite 102 and the NCC 106. As shown in FIG. 2, the NCC 106 includes a control/management tunnel termination module 210, coupled to a resource management module 220, a network management module 230 and a call control module 240. The network management module 230 is also coupled to the resource management module 220 and the call control module 240.

The control/management tunnel termination module 210 receives inbound signals and transmits outbound signals. The control/management tunnel termination module 210 provides a security feature for signaling channels between the NCC 106 and the ground base stations 104 and 120. In addition, the control/management tunnel termination module 210 also provides an authentication of the ground base stations 104 and 120 to the NCC 106 in order to eliminate the risk of bandwidth theft or disruption of services.

The resource management module 220 carries out a call admission check for resources during a call setup which occurs when the ground base station 104 and/or 120 wishes to transmit a signal. The resource management module 220 also allocates, de-allocates and controls the bandwidth resources. Further, the resource management module 220 provides for control of the ATM switch 112 resources as well as control of congestion of the output buffer 114 of the satellite 102.

The call control module 240 establishes, maintains and terminates switched virtual circuits (SVCs). The call control module 240 also provides for address analysis and routing, VPI/VPC (routing code, or address) allocation and de-allocation and coordination of bandwidth resource allocation with the resource management module 220. The network management module 230 provides for permanent virtual circuit (PVC) connection.

The network management module 230 provides fault management, configuration management, accounting management, performance management, security management, and service management.

In operation, the NCC 106 controls the resource management of, resource allocation to, and establishment of virtual circuits either through a network management function for user requested virtual circuits. The user requested virtual circuits may include permanent virtual circuits (PVCs), which are allocated permanently by the NCC 106 between specific ground base stations, or ground based station requested switched virtual circuits (SVCs), which are established through connection control signaling. Each ground base station 104 and 120 has an associated SVC connection control function which requests connections to other ground based stations through the NCC 106, based on application need and available terminal resources, and responds to connection requests from other ground based station through the NCC 106, based on application availability and terminal resource availability. The SVC connection control function can realize a dynamic bandwidth-on-demand capability limited only by signaling delay and the processing power of the ground based stations 104 and/or 120, the other like ground based stations, and the NCC 106. The NCC 106 also controls a bandwidth-on-demand capability above and beyond that enabled by dynamic SVC connection control. The NCC 106 dynamically allocates bandwidth to already established virtual circuits of ground based stations through a request/response, client/server protocol with the ground based stations 104 and 120, and other like ground based stations, as clients and NCC 106 as server. In this scheme, some guaranteed bandwidth is allocated to PVCs and SVCs and an excess per inbound beam bandwidth pool, managed by the NCC 106, is used to service ground based station 104 and 120 demands for bandwidth beyond the guaranteed rate. The excess bandwidth is due to the over-sizing of inbound beam bandwidth relative to the outbound beam bandwidth. In the simple case where all inbound beams have the same bandwidth and all outbound beams have the same bandwidth, the ratio of inbound beam bandwidth to outbound beam bandwidth, and the amount of output buffering per outbound beam, determines the amount statistical multiplexing gain achievable by the satellite switch. Further statistical multiplexing is also realized within each user terminal.

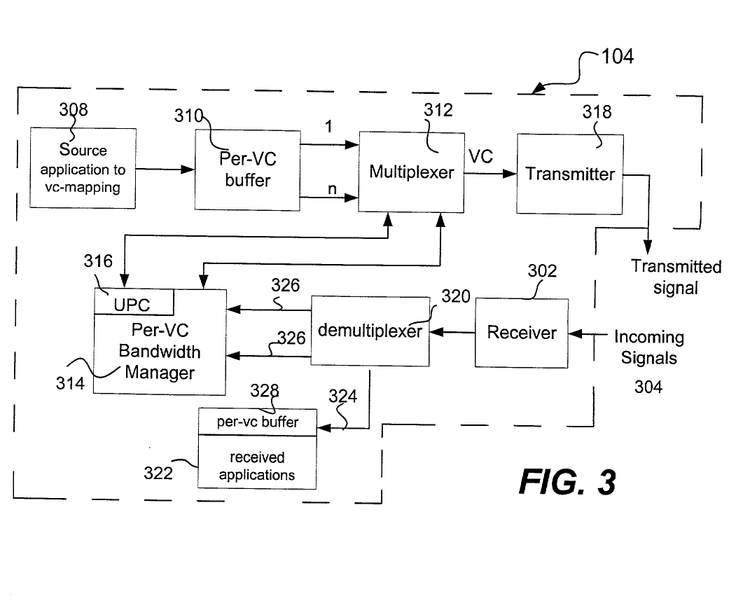

FIG. 3 shows a block diagram of the ground based station 104 in greater detail. In general, the signal transmission in the ground based station 104 involves outbound and inbound signal processing and transmission.

In FIG. 3, the ground based station 104 includes a receiver 302 for receiving incoming signals 304 from signal sources, for example, the satellite 102, the second ground based station 120 or the network control center 106. The ground based station 104 also generates a source application to VC-mapping 308 to be transmitted to the satellite 102. The ground based station 104 also includes a multiplexer 312 for processing source application to VC-mapping 308 and a demultiplexer 320 for processing and assembling the incoming signals 304. The ground based station 104 also includes a first per-VC buffer 310 and a second per-VC buffer 328 to store the processed source application to VC-mapping and incoming signals 304.

In accordance with one embodiment of the invention, the receiver 302 receives the incoming signals 304 which include communication signals from the ground based station 120 and control signals from the network control center 106. The demultiplexer 320 then demodulates and decodes the received incoming signals. In the case that the incoming signals 304 are communication signals from the ground based station 120 (as shown by arrow 324), the communication signals 324 are then classified as received applications 324 and are stored in the second per-VC buffer 328. In the case that the incoming signals 304 are control signals from the network control center 106 (as shown by arrows 326), the signals 326 will be further processed.

As shown in FIG. 3, in addition to the multiplexer 306 and demultiplexer 320 and the first per-VC buffer 310 and the second per-VC buffer 328, the ground based station further includes a per-VC bandwidth manager 314 for managing a bandwidth of each of the virtual circuits used for transmission in response to the control signals 326 received by the receiver 302 and a transmitter 318 for transmitting the source application to VC-mapping 308. In one embodiment of the invention, the control signals may include signals indicating congestion in the on-board output buffer 114 of the satellite 102, rain attenuation and response signals from the network control center 106. In an alternative embodiment, the transmitter 316 and the receiver 302 can be embodied in a single device.

The per-VC bandwidth manager 314 may further include a user parameter control (UPC) device 316. The UP 316 may also be a separate device from the per-VC bandwidth manager 314. The UP 316 detects and controls the source application to VC-mapping 308 to prevent a second signal transmission from interrupting an on-going first signal transmission. The UPC 316 also performs bandwidth shaping. In response to the congestion signal of the buffer 114 of the satellite 102, the UPC 316 further reduces the bandwidth apportioned to the virtual circuit which causes the congestion of the buffer 114 of the satellite 102.

In operation, the source application to VC-mapping 308 generated by the ground based station 104 are processed into ATM packets by the multiplexer 312 which assigns the same routing codes to those ATM packets having the same destination so that these ATM packets are transmitted via a common virtual circuit to the destination. These outgoing ATM packets are then stored in the buffer 310 for later transmission.

The receiver 302 may receive incoming signals 304 from the satellite 102. The incoming signals 304 are then processed in the demultiplexer 320 to determine if the incoming signals 304 are communication signals 324 or control signals 326. As described above, if the incoming signals 304 are communication signals 324, the signals are stored in the second per-VC buffer 328 of the received application 322. Otherwise, the incoming control signals 326 are directed to the per-VC bandwidth manager 314. The per-VC bandwidth manager 314 assigns each virtual circuit used to transmit the outgoing packets a bandwidth according to the control signals 326 received by the receiver 302 from the network control center 106. The UPC 316 shapes the bandwidth and negotiates the traffic control between various virtual circuits. The signal is then directed to the transmitter 318 for transmission.

In another embodiment, the ground based station 104 sends request packets to the network control center 106 according to the number of the packets stored in the first per-VC buffer 310 to request an update of the bandwidths of the virtual circuits. The network control center 106 then grants or denies the request based on a fairness criterion involving the requirements of all user terminals and the priority levels of the respective virtual circuit.

Each ground based station 104 and 120, and all like ground based stations in the system, controls the configuration of its bandwidth management system. This configuration changes dynamically over time in response to the real-time needs of its applications and to the requirements of the network management invoked setup of PVCs. The bandwidth management system of the ground based stations 104 and 120 frames application data into packets, maps packets into appropriate virtual circuits, and multiplexes the virtual circuits into the inbound satellite beam of the ground based station 104 and 120. Each ground based station 104 and 120, and all like ground based stations, determines its required portion of the inbound beam bandwidth based on its application's needs and negotiates with the NCC via call control signaling for a guaranteed allocation. Each ground based station 104 and 120, and all like ground based stations, negotiates changes in the inbound beam bandwidth it requires beyond its guaranteed rate, which is the sum of the guaranteed rates of its virtual circuits. It statistically oversubscribes its negotiated bandwidth by priority queuing the virtual circuits and multiplexing them, based on priority, into the inbound beam. The priority queuing and multiplexing can be implemented using various optimization techniques.

In accordance with one or more embodiments of the invention, a function of the network control center 106, or, in particular, the resource management module 220, is to control how the ground based stations in each inbound beam gain access to their beam by changing, based on terminal population, time of day, month or year, etc., the configuration of the frequency and time slots associated with each inbound beam. This determines how the demultiplexer 118 demultiplexes the inbound beams.

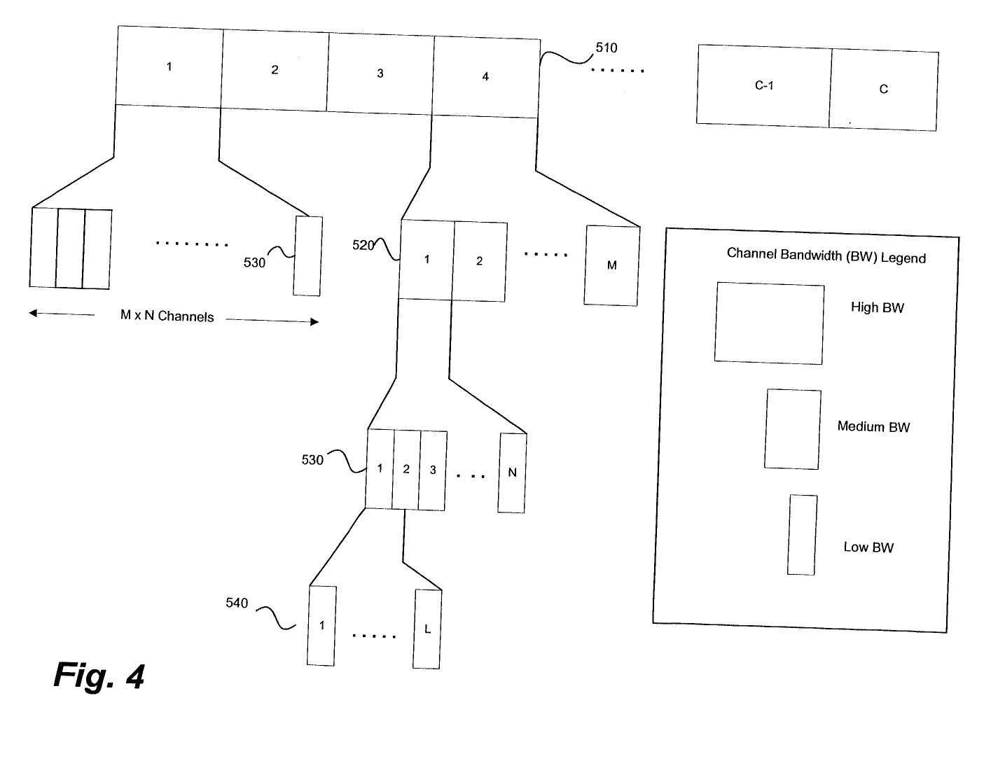

FIG. 4 is an exemplary diagram showing the up-link frequency channelization in accordance with one embodiment of the invention. For example, FIG. 4 illustrates frequency channelization which could be used for a satellite system such as that provided in the Astrolink FCC filing, filed by Lockheed Martin on Sep. 27, 1995 and incorporated herein by reference. It is important to note that the channelization is controlled by the NCC 106 in accordance with an embodiment of the invention. In this case, the satellite operates in 1.0 GHz of up-link bandwidth and in 1.0 GHz of down-link bandwidth. The up-link bandwidth associated with each up link antenna beam of the multi-beam antenna can be split up into some number of channels which are each channelized as exemplified in FIG. 4. In this example, the up-link satellite beam multiple access carried out by the terminals, and which results in a multiplexed up link beam (i.e., combined signal) may be implemented with multi-frequency time-division multiple access (MF-TDMA or FDMA/TDMA). Other techniques can also be used, such as code-division multiple access (CDMA) or frequency-division multiple access (FDMA) or a combination of these techniques.

FDMA is very similar to MF-TDMA. The distinction between these two techniques is that a given terminal is time-division multiplexed into a single frequency. Moreover, since TDMA is not used on the single frequency, as in MF-TDMA, this terminal must use the frequency continuously. Thus, in FDMA, terminals cannot migrate over the course of a call from one frequency to another under the control of the demand-assignment multiple access (DAMA) algorithm to enable bandwidth-on-demand as described in connection with FIG. 3.

In CDMA, a single frequency is used by many terminals, which can typically access the frequency at will. Of significance, in CDMA, transmissions of the terminals are sorted on the satellite essentially by a correlation detector, which knows the same code sequences as used by the terminals. Multiple frequencies can be used with CDMA, resulting in a multiple frequency CDMA system (MF-CDMA). Note that bandwidth-on-demand is essentially automatic with CDMA, although a discipline must be used to control the number of terminals on a single frequency for interference reasons.

While specific embodiments of the invention have been described herein, it will be apparent to those skilled in the art that various modifications may be made without departing from the spirit and scope of the invention.

We claim:

1. A satellite communications network system for handling fixed size data packets, comprising:
at least one ground based station for transmitting an uplink communication signal representing the fixed sized data packets and for receiving a control signal;
at least one satellite for receiving the uplink communication signal from the at least one ground based station and for transmitting a downlink communication signal; and
at least one ground control station for transmitting and receiving control signals from the satellite, wherein the satellite receives and transmits the control signals to the at least one ground based station.

2. The satellite communication system in accordance with claim 1, wherein the fixed size data packets are transmitted via at least one virtual circuit and each of the fixed size data packets includes a destination code and a routing code and wherein, the fixed size data packets having a same destination and routing code are transmitted via a same virtual circuit.

3. The satellite communication system in accordance with claim 1, wherein the fixed size data packets are Asynchronous Transfer Mode (ATM) data packets.

4. The satellite communication system in accordance with claim 1, wherein the at least one ground based station includes:
a signal generator for generating the fixed sized data packets;
a virtual circuit generator coupled to the signal generator for establishing virtual circuits used for transmitting the fixed size data packets;
a pre- virtual circuit bandwidth manager coupled to the virtual circuit generator for managing a bandwidth of each of the virtual circuits generated by the virtual circuit generator; and
a transmitting unit for transmitting the fixed size data packets to the satellite via the virtual circuits.

5. The satellite communication system in accordance with claim 4, wherein the virtual circuits established by the virtual circuit generator includes at least permanent virtual circuit (PVC) and at least one switched virtual circuit (SVC).

6. The satellite communication system in accordance with claim 5, wherein the switched virtual circuits are established temporarily when the at least one ground based station connects with a second ground based station via the at least one ground based control station.

7. The satellite communication system in accordance with claim 4, wherein the at least one ground based station includes:
a receiving unit for receiving the downlink signal from the satellite; and
a buffer for buffering the fixed sized data packets before transmission.

8. The satellite communication system in accordance with 4, wherein the pre- virtual circuit manager further includes a user parameter control device coupled to the virtual circuit generator for shaping the bandwidth of each of the virtual circuits before the fixed size data packets are transmitted.

9. The satellite communication system in accordance with claim 4, wherein the user parameter control device changes the bandwidths for the virtual circuits according to control signals transmitted from the at least one ground control station via the satellite.

10. The satellite communication system in accordance with claim 4, wherein the at least one ground based station further includes a dynamically statistical multiplexer for transmitting the fixed size data packets with a shared available transmission bandwidth allocated to the ground based station.

11. The satellite communication system in accordance with claim 4, wherein the at least one ground based station includes a bandwidth manager coupled to the virtual circuit generator for managing a bandwidth of each of the virtual circuits generated by the virtual circuit generator.

12. The satellite communication system in accordance with claim 4, wherein the ground based station is a computer terminal.

13. The satellite communication system in accordance with claim 1, wherein the satellite includes:
a receiver system for receiving signals from the ground based station and the ground control station;
a switch coupled to the signal processor for switching the fixed size data packets to various selected destinations;
an output buffer coupled to the switch for buffering the fixed size data packets; and
a transmitter for modulating and transmitting the fixed size data packets from the output buffer to the at least one ground based station and the at least one ground control station.

14. The satellite communications system in accordance with claim 13, further including:
a first signal processor coupled to the receiver for processing the signals received by the receiver; and
a second signal processor coupled to the transmitter for processing the fixed sized data packets to be transmitted by the transmitter.

15. The satellite communication system in accordance with claim 13, wherein the output buffer includes a plurality of sub-buffers.

16. The satellite communication system in accordance with claim 13, wherein the switch discards one or more of the fixed size packets when the received fixed size data packets indicates an incomplete transmission.

17. The satellite communication system in accordance with claim 13, further including a controller for processing control signals transmitted from the at least one ground control center.

18. The satellite communication system as claimed in claim 13, wherein the first signal processor is a FFT processor.

19. The satellite communication system in accordance with claim 13, wherein the control signals indicates congestion of the fixed sized data packets in the output buffer.

20. The satellite communication system in accordance with claim 8, wherein when the user parameter control device monitors a congestion, the transmitter of the at least one ground based station transmits a request signal to request a change of the bandwidths of the virtual circuits to the at least one ground control station via the satellite.

21. The satellite communication system in accordance with claim 1, wherein the at least one ground control station includes:
a control/management tunnel termination module;
a resource management module coupled to the control/management tunnel termination module;
a call control module coupled to the control/management tunnel termination module; and
a network management module coupled to the control/management tunnel termination module.

22. The satellite communication system in accordance with claim 1, wherein the at least one ground control station includes:
a receiver for receiving the fixed size data packets from the satellite;
an admission control management device for determining if the received fixed size data packets is acceptable;
a channelization controller for controlling a plurality of up-link and down-link transmission channels so that the fixed size data packets can be transmitted via the plurality of channels; and
a transmitter for transmitting the fixed size data packets via the plurality of channels and a plurality of virtual circuits to the ground based station via the satellite, wherein the admission control management device allocates at least one bandwidth to at least one of the virtual circuits according to fairness criteria.

23. The satellite communication system in accordance with claim 22, wherein the plurality of channels are each divided into a plurality of frames and each of the frames is divided into a plurality of access slots.

24. The satellite communication system in accordance with claim 21, wherein the fairness criteria includes requirements and a priority level associated with the ground based station.

25. The satellite communication system as claimed in claim 21, wherein the admission control management device detects congestion of the fixed size data packets in order to re-assign the bandwidth of the virtual circuits.

26. A ground based station for a satellite communications system, comprising:
a signal generator for generating the fixed sized data packets;
a virtual circuit generator coupled to the signal generator for establishing virtual circuits used for transmitting the fixed size data packets;
a pre- virtual circuit bandwidth manager coupled to the virtual circuit generator for managing a bandwidth of each of the virtual circuits generated by the virtual circuit generator; and
a transmitting unit for transmitting the fixed size data packets to the satellite via the virtual circuits.

27. The ground based station in accordance with claim 26, wherein the virtual circuits established by the virtual circuit generator includes at least permanent virtual circuit (PVC) and at least one switched virtual circuit (SVC).

28. The ground based station in accordance with claim 27, wherein the switched virtual circuits are established temporarily when the at least one ground based station connects with a second ground based station via the at least one ground based control station.

29. The ground based station in accordance with claim 26, wherein the at least one ground based station includes:
a receiving unit for receiving the downlink signal from the satellite; and
a buffer for buffering the fixed sized data packets before transmission.

30. The ground based station in accordance with claim 26, wherein the pre- virtual circuit manager further includes a user parameter control device coupled to the virtual circuit generator for shaping the bandwidth of each of the virtual circuits before the fixed size data packets are transmitted.

31. The ground based station in accordance with claim 26, wherein the user parameter control device changes the bandwidths for the virtual circuits according to control signals transmitted from the at least one ground control station via the satellite.

32. The ground based station in accordance with claim 26, wherein the at least one ground based station further includes a dynamically statistical multiplexer for transmitting the fixed size data packets with a shared available transmission bandwidth allocated to the ground based station.

33. The ground based station in accordance with claim 26, wherein the at least one ground based station includes a bandwidth manager coupled to the virtual circuit generator for managing a bandwidth of each of the virtual circuits generated by the virtual circuit generator.

34. A satellite for a communications system, comprising:
a receiver system for receiving signals from the ground based station and the ground control station;
a switch coupled to the signal processor for switching the fixed size data packets to various selected destinations;
an output buffer coupled to the switch for buffering the fixed size data packets; and
a transmitter for modulating and transmitting the fixed size data packets from the output buffer to the at least one ground based station and the at least one ground control station.

35. The satellite for a communications system in accordance with claim 34, further including:
a first signal processor coupled to the receiver for processing the signals received by the receiver; and
a second signal processor coupled to the transmitter for processing the fixed sized data packets to be transmitted by the transmitter.

36. The satellite for a communications system in accordance with claim 35, wherein the switch discards one or more of the fixed size packets when the received fixed size data packets indicates an incomplete transmission.

37. The satellite for a communications system in accordance with claim 35, further including a controller for processing control signals transmitted from the at least one ground control center.

38. The satellite for a communications system in accordance with claim 35, wherein the control signals indicates congestion of the fixed sized data packets in the output buffer.

39. A ground based control station for a satellite communications system, comprising:
a control/management tunnel termination module;
a resource management module coupled to the control/management tunnel termination module;
a call control module coupled to the control/management tunnel termination module; and
a network management module coupled to the control/management tunnel termination module.

40. A ground based control station for a satellite communications system, comprising:
a receiver for receiving the fixed size data packets from the satellite;
an admission control management device for determining if the received fixed size data packets is acceptable;
a channelization controller for controlling a plurality of up-link and down-link transmission channels so that the fixed size data packets can be transmitted via the plurality of channels; and
a transmitter for transmitting the fixed size data packets via the plurality of channels and a plurality of virtual circuits to the ground based station via the satellite, wherein the admission control management device allocates at least one bandwidth to at least one of the virtual circuits according to fairness criteria.
